(19) United States
(12) Patent Application Publication
(10) Pub. No.: US 2026/0225474 A1
(43) Pub. Date: Aug. 6, 2026

(54) MICROMOBILITY DEVICE WITH BATTERY LOCK

(71) Applicant: Also, Inc., Palo Alto, CA (US)

(72) Inventors: Sanket Parshuram PHALGAONKAR, San Francisco, CA (US); Adam Christopher BENDER, San Francisco, CA (US); Jonathan Louis HALL, Menlo Park, CA (US)

(73) Assignee: Also, Inc., Palo Alto, CA (US)

(21) Appl. No.: 19/531,020

(22) Filed: Feb. 5, 2026

Related U.S. Application Data
(60) Provisional application No. 63/754,793, filed on Feb. 6, 2025.

(51) Int. Cl. B60L 50/64; B60K 1/04; B60L 50/20

(52) U.S. Cl. CPC B60L 50/64; B60K 1/04; B60L 50/20; B60L 2200/12; B60L 2240/54; B60L 2250/16

(57) ABSTRACT

A micromobility device can include a battery pack having a lock assembly with a handle coupled with a lock interface. The lock interface can define a first opening and a second opening. The handle can rotate the lock interface from a first position to a second position. The battery pack can include an actuator assembly including a first lock mechanism, a second lock mechanism, and an actuator, the actuator can move the second lock mechanism from an unlocked position to a locked position. The first opening can receive the first lock mechanism with the lock interface in the first position and retain the first lock mechanism with the lock interface in the second position. The second opening can receive the second lock mechanism with the lock interface in the second position and the second lock mechanism in the locked position.

### CROSS-REFERENCE TO RELATED APPLICATION

This U.S. Patent Application claims the benefit of and priority to U.S. Provisional Application No. 63/754,793, filed February 6, 2025, the entire disclosure of which is hereby incorporated by reference in its entirety.

### BACKGROUND

Bicycles can include an electric motor that receives power from a battery.

### SUMMARY

At least one aspect is directed to an apparatus. The apparatus can be a micromobility device. The micromobility device can include a frame. The frame can define a cavity. The micromobility device can include a first wheel and a second wheel rotatably coupled with the frame. The micromobility device can include a drive unit coupled with the frame. The drive unit can rotate the second wheel. The micromobility device can include an actuator assembly positioned within the cavity. The actuator assembly can include a first lock mechanism, a second lock mechanism, and an actuator. The actuator can move the second lock mechanism from an unlocked position to a locked position. The micromobility device can include a battery pack detachably coupled with the frame and positioned within the cavity. The battery pack can include a lock assembly. The lock assembly can include a handle coupled with a lock interface. The lock interface can define a first opening and a second opening, the handle to rotate the lock interface from a first position to a second position. The first opening can receive the first lock mechanism with the lock interface in the first position. The first opening to retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position. The battery pack can be coupled with the frame with the lock interface in the second position and the second lock mechanism in the locked position.

At least one aspect is directed to an apparatus. The apparatus can be a battery pack. The battery pack can include a lock assembly. The lock assembly can include a handle coupled with a lock interface. The lock interface can define a first opening and a second opening. The handle can rotate the lock interface from a first position to a second position. The battery pack can include or be selectively coupled with an actuator assembly. The actuator assembly can include a first lock mechanism, a second lock mechanism, and an actuator. The actuator can move the second lock mechanism from an unlocked position to a locked position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position.

At least one aspect is directed to a method of coupling a battery pack with the frame. The method can include providing a battery pack. The battery pack can include a lock assembly. The lock assembly can include a handle coupled with a lock interface. The lock interface can define a first opening and a second opening. The handle can rotate the lock interface from a first position to a second position. The method can include providing an actuator assembly. The actuator assembly can include a first lock mechanism, a second lock mechanism, and an actuator. The actuator can move the second lock mechanism from an unlocked position to a locked position. The method can include receiving, by the first opening, the first lock mechanism with the lock interface in the first position. The first opening can retain the first lock mechanism with the lock interface in the second position. The method can include operating the actuator can move the second lock mechanism to the locked position with the lock interface in the second position. The method can include receiving, by second opening, the second lock mechanism with the lock interface in the second position and the second lock mechanism in the locked position.

At least one aspect is directed to a method. The method can include providing a bike. The bike can include a frame. The frame can define a cavity. The bike can include a first wheel and a second wheel rotatably coupled with the frame. The bike can include a drive unit coupled with the frame. The drive unit can rotate the second wheel. The bike can include an actuator assembly positioned within the cavity. The actuator assembly can include a first lock mechanism, a second lock mechanism, and an actuator. The actuator can move the second lock mechanism from an unlocked position to a locked position. The bike can include a battery pack detachably coupled with the frame and positioned within the cavity. The battery pack can include a lock assembly. The lock assembly can include a handle coupled with a lock interface. The lock interface can define a first opening and a second opening, the handle to rotate the lock interface from a first position to a second position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position. The battery pack can be coupled with the frame with the lock interface in the second position and the second lock mechanism in the locked position.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example bike, in accordance with some aspects.

FIG. 2 depicts a frame of a bike, in accordance with some aspects.

FIG. 3 depicts a frame of a bike and a battery pack, in accordance with some aspects.

FIG. 4 depicts an actuator assembly of a bike, in accordance with some aspects.

FIG. 5 depicts an actuator assembly of a bike, in accordance with some aspects.

FIG. 6 is an exploded view of an actuator assembly of a bike, in accordance with some aspects.

FIG. 7 depicts a battery pack of a bike with a lock assembly in an unlocked position, in accordance with some aspects.

FIG. 8 depicts a battery pack of a bike with a lock assembly in an unlocked position, in accordance with some aspects.

FIG. 9 depicts a battery pack of a bike with a lock assembly in a locked position, in accordance with some aspects.

FIG. 10 depicts a battery pack of a bike with a lock assembly in a locked position, in accordance with some aspects.

FIG. 11 is a partial cross-sectional view of a frame and a battery pack of a bike, in accordance with some aspects.

FIG. 12 is a partial cross-sectional view of a battery pack and an actuator assembly of a bike, in accordance with some aspects.

FIG. 13 depicts an actuator assembly and lock interface of a bike, in accordance with some aspects.

FIG. 14 depicts a partial cross-sectional view of an actuator assembly and lock interface of a bike, in accordance with some aspects.

FIG. 15 is a block diagram illustrating an architecture for a computer system that can be employed to implement elements of the systems and methods described and illustrated herein, including, for example, the lock assembly of FIGS. 1-14.

FIG. 16 is an example method of providing a bike, in accordance with some aspects.

FIG. 17 is a flow diagram of an example method of coupling the battery pack with the frame.

### DETAILED DESCRIPTION

Following below are more detailed descriptions of various concepts related to, and implementations of, methods, apparatuses, and systems of integrating feedback systems into bicycles. The various concepts introduced above and discussed in greater detail below may be implemented in any of numerous ways.

The technical solutions are generally directed to a micromobility device, such as a bicycle (bike), among other micromobility devices. The micromobility device can include at least one drive unit (e.g., a propulsion system), at least one wheel, at least one battery pack, and a frame. The drive unit, the wheel, and the battery pack can be coupled with the frame. The drive unit can rotate the wheel to propel the micromobility device. The micromobility device can include the battery pack to power the drive unit and rotate the wheel with or without application of a mechanical force to a pedal assembly by the user. For example, the micromobility device can the propelled by a mechanical force provided by the user to the pedal assembly, by an electrical force provided by a battery pack to a motor, or some combination thereof.

The battery pack of the micromobility device can include a lock assembly to selectively couple the battery pack with the frame of the micromobility device. For example, the lock assembly can include a handle that is accessible by a user. Coupling the battery pack can be both a physical and an electrical coupling of the battery pack with the micromobility device so that the battery pack is physically retained on the micromobility device while also being electrically coupled to the micromobility device to power the micromobility device during various operations of micromobility device. The lock assembly can include a lock interface having at least one first opening, at least one second opening. The lock assembly of the battery pack can engage with an actuator assembly. The actuator assembly can be positioned on the frame of the micromobility device. The first opening of the lock interface can engage with a first lock mechanism of the actuator assembly. For example, the first opening of the lock interface can include a helical profile to physically retain the first lock mechanism of the actuator assembly within the interface and compress the battery pack against the frame. The second opening of the lock interface can engage with a second lock mechanism of the actuator assembly. For example, the second lock mechanism can selectively move (e.g., be actuated by a motor) from an unlocked position to a locked position. In the locked position, the second lock mechanism of the actuator assembly can be positioned at least partially within the second opening of the lock interface of the battery pack. The first opening of the lock interface can physically couple the battery pack with the frame when in the locked position, while the second lock mechanism can prevent the lock assembly from moving from the locked position to an unlocked position when the second lock mechanism is in a locked position.

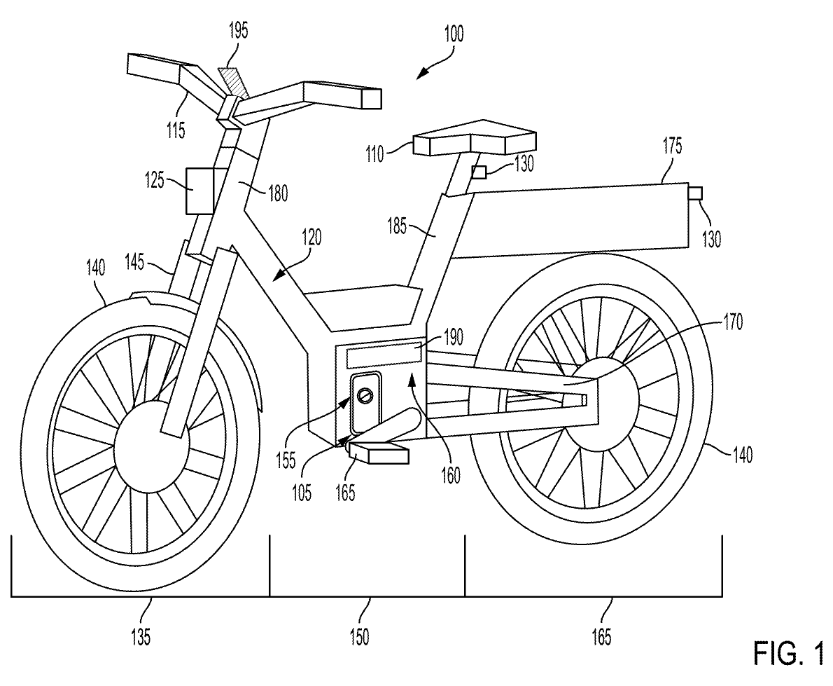

FIG. 1 depicts an example perspective view of a micromobility device 100. As shown in FIG. 1, among others, the micromobility device 100 is can be a bike. For example, the micromobility device 100 can be an electric bike 100 installed with at least one battery pack 105. The micromobility device 100 can be a human-operated micromobility device 100. The micromobility device 100 can include single rider bicycles, tandem bicycles, cargo bicycles, motor-assist bicycles, pedicabs, electric-assist bicycles, road bicycles, mountain bicycles, electric scooters, electric skateboards, segways, or unicycles, among others. The battery pack 105 can also be used as an energy storage system to power a building, such as a residential home or commercial building.

A micromobility device 100 structured as an a bike (also referred to herein as bike 100, bicycle 100, electric bike 100, e-bike 100, or other similar variations thereof) can be fully electric or partially electric (e.g., pedal-powered). The electric bike 100 can be fully autonomous, partially autonomous, semi-autonomous, or unmanned. The electric bike 100 can also be human operated or non-autonomous. A human operator or the rider of the bike 100 can sit on a saddle 110 to operate the bike 100. The rider of the bike 100 can steer, grip, balance, or otherwise control the bike 100 using the handlebar 115.

The bike 100 can include a frame 120. The frame 120 can support various components of the bike 100, such as a handlebar 115, the saddle 110, the battery pack 105, at least one front light assembly 125, and at least one rear light assembly 130. The frame 120 can span a front portion 135. The front portion 135 can support, be coupled with, or include, for example, a wheel 140 of the bike 100, a fork 145 of the bike 100, a head tube 180 of the bike 100, the handlebar 115, the front light assembly 125, among other components. The bike 100 can include two or more wheels 140 (e.g., a front wheel 140 and a rear wheel 140). The frame 120 can span a middle portion 150 (e.g., a central portion). The middle portion 150 can support, be coupled with, or include, for example, the saddle 110, the battery pack 105, a drive unit 160 of the bike 100, or a top tube 185, among other components.

The frame 120 can include the middle portion 150 including the rear light assembly 130. The frame 120 can include a rear portion 165. The rear portion 165 can support, be coupled with, or include, for example, a rear wheel 140 of the bike 100, the rear light assembly 130, a drivetrain 170 of the bike 100, or a rear member 175 of the bike 100, among other components. The drivetrain 170 of the bike can be a chain, gear, belt, or some combination thereof that couples the drive unit 160 with the rear wheel 140 of the bike 100 such that the drive unit 160 can rotate or drive the rear wheel 140. The rear member 175 of the bike 100 can be a rear fender, a rack configured to stow or support luggage or some other object, a child seat, a pet carrier, a basket, or some other object. The battery pack 105 can be disposed anywhere within the frame 120.

The bike 100 can include at least one battery pack 105 that can include at least one battery, at least one battery module, or at least one battery cell. The battery pack 105 can be electrically coupled with the bike 100 (e.g., to the drive unit 160, to the front light assembly 125, the rear light assembly 130, or some other component(s)). For example, the battery pack 105 can provide electrical energy to the bike 100 to power the bike 100. The battery pack 105 can provide electrical energy to the drive unit 160 to cause the drive unit 160 to operate (e.g., to rotate the wheel 140 of the bike 100). The battery pack 105 can be installed or placed within the bike 100. For example, the battery pack 105 can be installed on the frame 120 of the bike 100 within one or more of the front portion 135, the middle portion 150, or the rear portion 165. As depicted in FIGS. 1–3, among others, the battery pack 105 can be at least partially inserted into a cavity 155 of the frame 120. The cavity 155 can be positioned within the middle portion 150 of the frame 120, for example. In other examples, the cavity 155 can be positioned within or defined by some other portion of the bike 100.

The battery pack 105 can be detachably coupled with the frame 120 such that in can be removed (e.g., to charge the battery pack 105). The battery pack 105 can include or connect with at least one busbar, e.g., a current collector element. For example, the busbar can include electrically conductive material to connect or otherwise electrically couple the battery pack 105 with other electrical components of the bike 100 to provide electrical power to various systems or components of the bike 100, such as the front light assembly 125, the rear light assembly 130, or some other system. The battery pack 105 can selectively lock with the frame 120 so as to prevent separation of the battery pack 105 from the frame 120 with the battery in a locked position. The battery pack 105 can selectively unlock from the frame 120 so as to permit a user to remove the battery pack 105 from the frame 120. For example, the battery pack 105 can be inserted into the cavity 155 of the frame 120 and locked to the frame 120 prior to operation of the bike 100, and then unlocked from the frame 120 and removed from the cavity 155 upon conclusion of an operation of the bike 100 so that the battery pack 105 can be charged (e.g., using a battery charger separate from the bike 100). In another example, a first battery pack 105 can be removed and replaced with a second battery pack 105 so that a user can continue an operation of the bike 100 despite a state of charge of the first battery pack 105 becoming diminished during operation of the bike 100. Because the battery pack 105 can lock to the frame 120, theft or certain or out of tolerance electrical conditions can be prevented. Locking the battery pack 105 to the frame 120 can further prevent vibration of the battery pack 105 relative to the frame 120 during operation of the bike 100, so as to minimize or reduce a likelihood that the battery pack 105 or the frame 120 (e.g., an electrical connector of the battery pack 105 or the frame 120) will be damaged during operation of the bike 100.

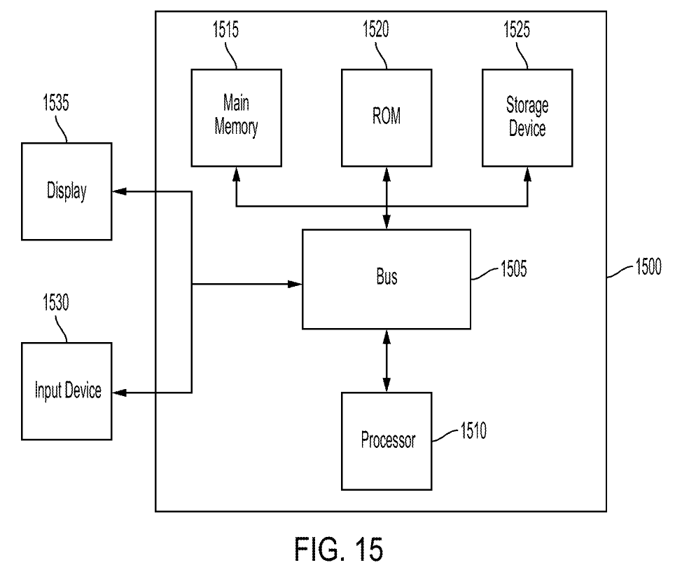

As depicted in FIG. 1, among others, the bike 100 can include at least one drive unit 160, a control device 190, and a user interface 195. The control device 190 can be coupled with the user interface 195. The control device 190 can be further coupled to and the drive unit 160. The user interface 195 can be or include an interface (e.g., a graphical user interface, at least one button, switch, or actuator, or some other interface) to allow a user (e.g., a rider) to affect or influence an operation of the bike 100. For example, a user can make a selection via the user interface 195, and the user interface 195 can provide a signal to the control device 190, where the control device 190 can further control or otherwise affect an operation of the bike 100. For example, the control device 190 can affect an operation of the drive unit 160 or some component thereof based on a user input provided via the user interface 195. The user interface 195 can be coupled with the bike 100 (e.g., physically coupled with the handlebar 115 of the bike 100). The user interface 195 can be remote or external to the bike 100, such as a user mobile device (e.g., a phone, a tablet, a smart watch, or some other mobile device). The control device 190 can be a printed circuit board assembly (PCBA), a CAN controller, or some other controller or computing system, such as the computing system 1500 discussed below with reference to FIG. 15.

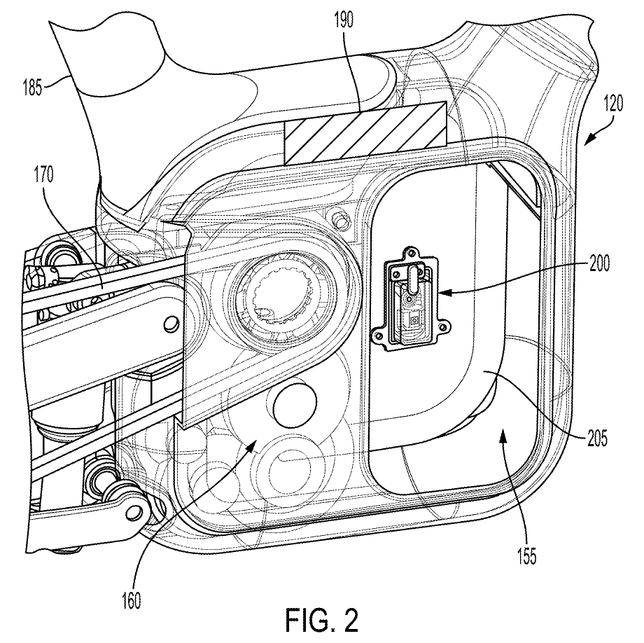

As depicted in FIGS. 2, 4-6, and 11-14, among others, the bike 100 can include at least one actuator assembly 200. The actuator assembly 200 can be positioned at least partially within the cavity 155. For example, the cavity 155 can include a surface 205, which can be a surface of the drive unit 160 that is accessible within the cavity 155. The actuator assembly 200 can be positioned on or accessible via the surface 205. The actuator assembly 200 can be coupled with the frame 120 (e.g., coupled with the surface 205, which can be part of the frame 120). For example, the actuator assembly 200 can be integrated with the frame 120 or otherwise a part of the frame 120. The actuator assembly 200 can selectively couple with the battery pack 105 to couple the battery pack 105 with the frame 120. For example, the battery pack 105 can selectively couple with the actuator assembly 200 within the cavity 155 to couple the battery pack 105 with the frame 120. When the battery pack 105 is decoupled from the frame 120 (e.g., decoupled from the actuator assembly 200), the battery pack 105 can be removed from the frame 120 while the actuator assembly 200 remains coupled with the frame 120.

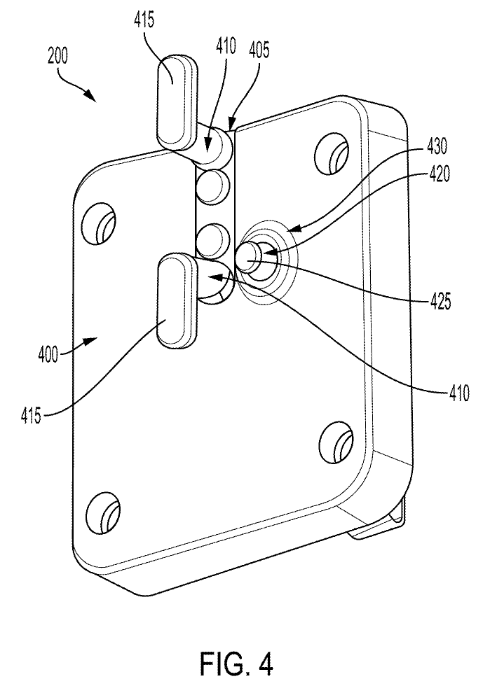

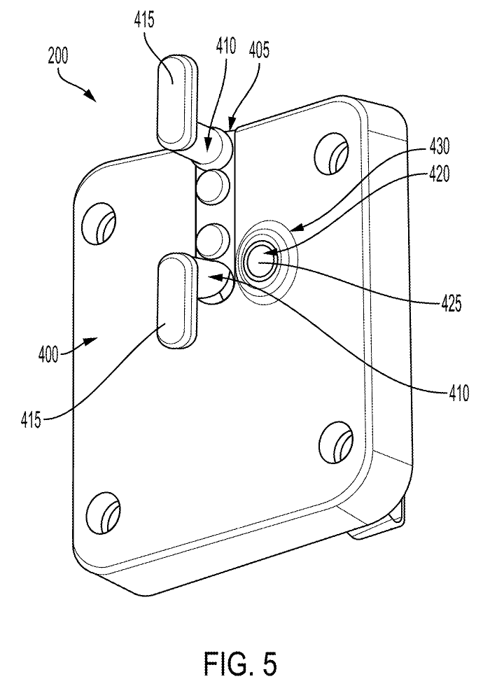

The actuator assembly 200 can include a housing 400. The housing 400 can be coupled with the surface 205 of the frame 120 the actuator assembly 200 with the frame 120. The actuator assembly 200 can include a housing seal 630. The housing seal 630 can be an O-ring, or a gasket, among other sealing devices. The housing seal 630 can be positioned between the housing 400 and the surface 205 of the frame to create a hermetic seal between the housing 400 and the surface 205 of the frame 120. The actuator assembly 200 can include at least one first lock mechanism 405 and at least one second lock mechanism 420 (e.g., a pin). The first lock mechanism 405 can be coupled with the housing 400 in a manner such that the first lock mechanism 405 does not move relative to the housing 400. The second lock mechanism 420 can be movably coupled with the housing 400 such that a position of the second lock mechanism 420 can change with operation of the actuator assembly 200. The first lock mechanism 405 can include at least one projection 410. In the example depicted in FIGS. 4 and 5, for example, the first mechanism 405 can include two projections 410 that are diametrically opposed. In other examples, the first mechanism 405 can include one projection 410 or some other number of projections 410 that can be diametrically opposed, or otherwise oriented. The projection 410 can include at least one finger 415. The finger 415 can extend radially or outward from the projection 410. The finger 415 can be positioned on a top or end of the projection 410. In various examples, each projection 410 can include at least one finger 415.

The second lock mechanism 420 of the actuator assembly 200 can move from an unlocked position, as depicted in FIG. 5, among others, to a locked position as depicted in FIG. 5, among others. For example, the second lock mechanism 420 can include a body 615 and an end 425. The body 615 can be positioned within the housing 400. The end 425 can selectively protrude from an opening 430 of the housing 400. For example, the end 425 of the second lock mechanism 420 can protrude from the opening 430 of the housing 400 with the second lock mechanism 420 in a locked position. When the second lock mechanism 420 is in an unlocked position, the end 425 of the second lock mechanism 420 can be flush with a surface of the housing 400, recessed within the housing 400, or recessed relative to a position of the end 425 with the second lock mechanism 420 in the locked position.

The actuator assembly 200 can include an actuator 600. The actuator 600 can be a motor 600. The motor 600 can rotate a shaft 605. The shaft 605 can include or be coupled with a gear 610 or gear portion having gear teeth. The shaft 605 can couple with the gear 610 such that actuation of the motor 600 can cause rotation of the shaft 605, which can further cause rotation of the gear 610. For example, the shaft 605 and the gear 610 can be keyed. The motor 600 can be actuated in response to an electrical signal, such as a signal provided by the control device 190 (e.g., a signal provided by the control device 190 in response to a user input via the user interface 195 or in response to a signal from a sensor, or otherwise). The gear 610 can be operatively coupled with the second lock mechanism 420. For example, the body 615 of the second lock mechanism 420 can include a gear portion 620, such as a linear gear portion 620. The gear portion 620 can engage with the gear 610 such that actuation of the motor 600 (which can cause rotation of the shaft 605 and rotation of the gear 610) can cause movement of the second lock mechanism 420. For example, actuation of the motor 600 can cause a linear movement of the second lock mechanism 420. Movement of the second lock mechanism 420 via engagement of the gear portion 620 with the gear 610 can cause the second lock mechanism 420 to move from the unlocked position to the locked position or vice versa. For example, rotation of the gear 610 in a first direction based on a first actuation of the motor 600 can cause the second lock mechanism 420 to move from the unlocked position to the locked position. Rotation of the gear 610 in a second direction based on a second actuation of the motor 600 can cause the second lock mechanism 420 to move from the locked position to the unlocked position.

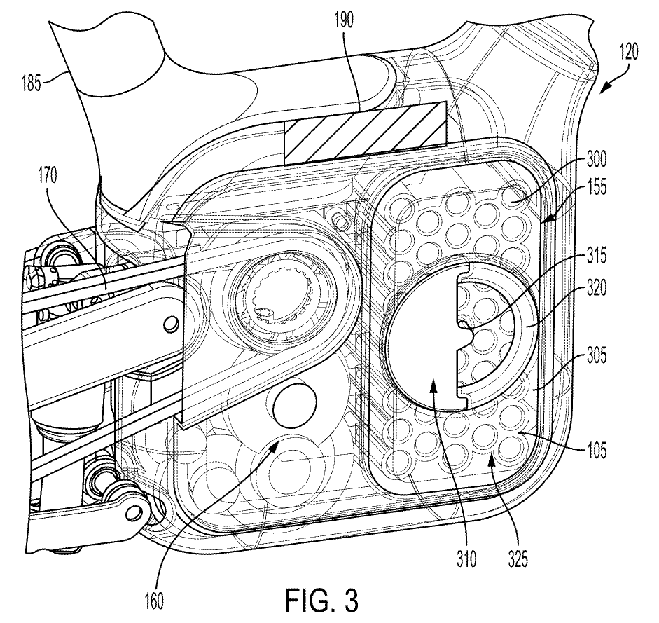

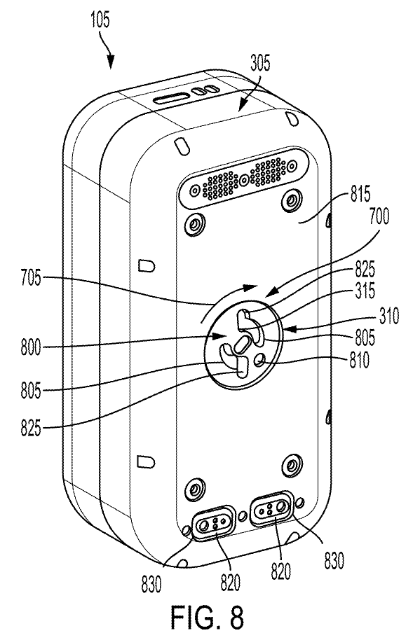

As depicted in FIGS. 3 and 7–14, among others, the bike 100 can include the battery pack 105 coupled with the frame 120 and positioned at least partially within the cavity 155 of the frame 120. The battery pack 105 can be selectively coupled to frame 120. The battery pack 105 can include at least one battery cell 300 (e.g., a plurality of battery cells 300) positioned within a housing 305 of the battery pack 105. The housing 305 of the battery pack 105 can include a first surface 325 (e.g., a front surface, a top surface, an outward-facing surface) and a second surface 815 (e.g., a back surface, a bottom surface, and inward-facing surface), as depicted in FIG. 8, among others. When coupled with the frame 120, the battery pack 105 can be positioned at least partially within the cavity 155. For example, the battery pack 105 can be positioned within the cavity 155 such that the battery pack 105 can engage with the actuator assembly 200 and couple the battery pack 105 with the frame. The battery pack 105 can include a shape or form factor that generally corresponds to a shape or form factor of the cavity 155. In other examples, the battery pack 105 can include a shape or form factor that differs from a shape or form factor of the cavity 155.

The battery pack 105 can include at least one lock assembly 310. The lock assembly 310 can selectively engage with the actuator assembly 200. For example, the lock assembly 310 can include a handle 320 coupled with a lock interface 800, as depicted in FIG. 8, among others. The handle 320 can be coupled with the lock interface 800 via an axle 315. For example, the handle 320 and the lock interface 800 can rotate about an axis defined by the axle 315. As depicted in FIG. 3, among others, the handle 320 can be rotated about the axis defined by the axle 315 to move the lock assembly 310 from an unlocked position to a locked position or from a locked position to an unlocked position. The handle 320 can be configured to enable rotation by a user of handle 320 without the use of tools. The handle 320 can be hinged or otherwise configurable to, in a first state, extend from the battery pack 105 and, in a second state, not extend from battery pack 105 (e.g., be parallel to first surface 325).

In examples, the battery pack 105 is configured to enable a user of a micromobility device to manually lock/unlock the battery pack 105 to enable or disable removal of battery pack 105 from a frame of a micromobility device without the use of tools (e.g., a user can manually, rotate handle 320 when it is extended from battery pack 105 using his/her hand). Additionally, the same locking mechanism (e.g., lock assembly 310) that is actuatable by a user can be locked by an electromechanical actuator (e.g., via actuator assembly 200) to advantageously reduce redundant parts and to provide feedback to a user in the state of the locking mechanism.

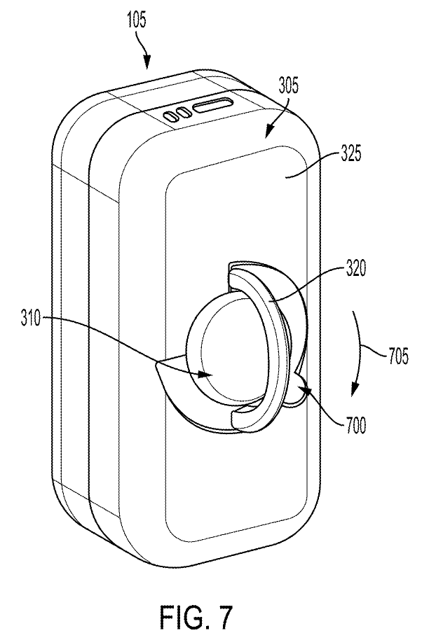

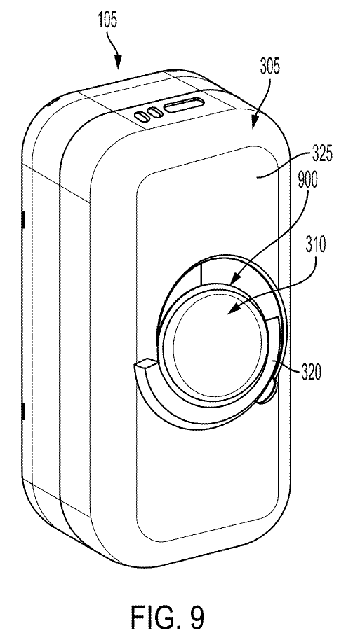

As depicted in FIGS. 7 and 9, among others, the first surface 325 of the battery pack 105 is shown. The lock assembly 310 of the battery pack 105 can include the handle 320. The handle 320 can be positioned proximate the first surface 325 of the battery pack 105. For example, the handle 320 can be accessible from the first surface 325 of the battery pack 105. For example, when the battery pack 105 is coupled with the actuator assembly 200, the first surface 325, and therefore the handle 320 at the lock assembly 310, can be accessible by a user to allow the user to engage the handle 320 to selectively remove the battery pack 105 from the cavity 155 of the frame 120. FIG. 7, among others, depict, the battery pack 105 with the lock assembly in an unlocked position 700. From the unlocked position 700, a user can rotate the handle 320 of a lock assembly 310 in a direction 705 to move the lock assembly 310 from the unlocked position 700 to a locked position 900, ask shown in FIG. 9, among others. In one example, a user can rotate the handle 320 of the lock assembly 310 90° or some other amount to move the lock assembly 310 from the unlocked position 700 to the locked position 900.

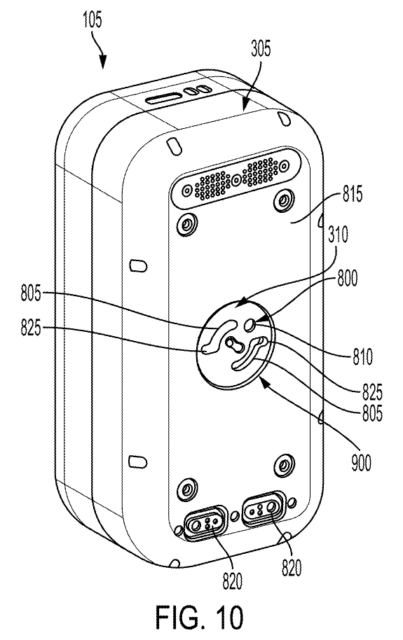

As depicted in FIGS. 8 and 10, among others, the second surface 815 of the battery pack 105 is shown. The lock assembly 310 of the battery pack 105 can include a lock interface 800. The lock interface 800 can be positioned proximate to the second surface 815 of the battery pack 105. For example, the lock interface 800 can be accessible from the second surface 815 of the battery pack 105. For example, when the battery pack 105 couples with the actuator assembly 200, the second surface 815, and therefore the lock interface 800 of the assembly 310, is positioned within the cavity 155 of the frame 120 so as to engage the actuator assembly 200. The lock interface 800 can include at least one first opening 805. The lock interface 800 can include at least one second opening 810. The first opening 805 can be an opening to receive the lock mechanism 405 of the actuator assembly 200. For example, the first opening 805 can include a shape or form factor that, in at least some respects, corresponds to a shape or form factor of the finger 415 of the lock mechanism 405. When the battery pack 105 is coupled with the actuator assembly 200, the finger 415 can be received by the opening 805 of the lock interface. For example, the opening 805 can include a portion 825 that has a shape and form factor that corresponds to a shape and form factor of the finger 415. The remaining portion of the first opening 805 (e.g., portions of first opening 805 other than the portion 825) can include a shape or form impact through that does not correspond to the 415 of the lock mechanism 405. For example, a remaining portion of the first opening can include a shape or form factor that corresponds to the projection 410 of the lock assembly. The battery pack 105 can further include at least one connector 820 (e.g., an electrical connector) for electrically coupling the battery pack 105 with the frame 120 of the bike 100 such that the battery pack 105 can provide power to propel or otherwise operate the bike 100. The connector 820 can be or include a pin connector, for example, such that the connector 820 receives pins extending from the cavity 155. The connector 820 can be accessible from a surface of the battery pack 105. For example, the housing 305 can include one or more openings through which the connector 820 of the battery pack 105 is accessible. A seal 830 can extend at least partially around a perimeter of the connector 820. The seal 830 can be or include a gasket or an O-ring comprising a compressible material.

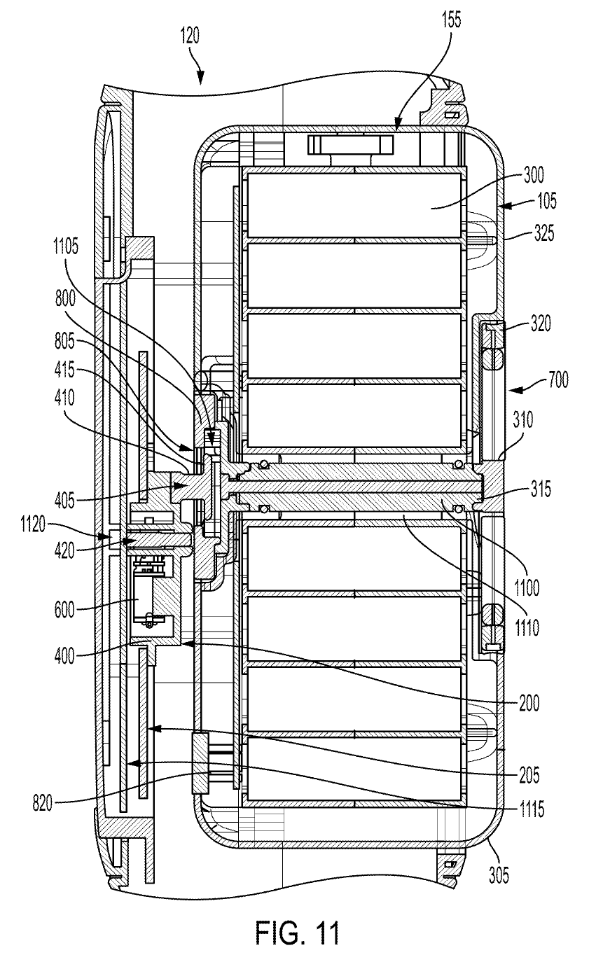

Inside the lock interface 800 (e.g., within the first opening 805), the lock interface 800 can include a shape or form factor that can receive the finger 415 the lock mechanism 405. However, because the remaining portion of the opening 805 (e.g., portions of the first opening 805 other than the portion 825) can have a shape or form factor that corresponds to the projection 410 is there smaller or differently than the finger 415, the opening 805 can trap or retain the finger 415 within the opening 805 as the projection of the lock mechanism 405 is moved through the remaining portion of the opening 805. The first opening 805 can include a curved profile. For example, the first opening 805 can extend along some radial distance of the lock interface 800. The first opening 805 can be positioned radially outward from the axle 315 of the lock assembly 310. As depicted in FIG. 11, among others, the lock interface 800 can include the first opening 805 having a helical profile 1105. For example, the first opening 805 can extend at least partially into the lock interface 800 at some depth. The depth of the first opening 805 can vary. For example, the first opening 805 can include a helical profile that extends in a direction toward the first surface 325 of the battery pack 105 from the lock interface 800. In this way, the depth of the first opening 805 that receives the finger 415 can be progressively shallower as the first opening 805 extends away from the portion 825.

The first opening 805 can receive the 415 of the lock mechanism 405 within the portion 825. The lock assembly 310 can be moved from the unlocked position 700 to the locked position 900 by rotating the lock assembly 310 (e.g., rotating the handle 320) in the direction 705. As the assembly 310 rotates in the direction 705 to move the lock assembly 310 from the unlocked position 700 to the locked position 900, the lock interface 800 can also rotate in the direction 705 with the finger 415 of the lock mechanism 405 the actuator assembly position within the opening 805. The finger 415 of the lock mechanism 405 can engage with the helical profile 1105 of the first opening 805. Engagement of the 415 with the helical profile 1105 of the first opening 805 allows the finger 415 to move in a direction toward the first surface 325 of the battery pack 105. Put another way engagement of the finger 415 with the helical profile 1105 of the first opening 805 can move the battery pack 105 further into the cavity 155 as the lock assembly 310 moves from the unlocked position 700 to the locked position 900. For example, the engagement of the helical profile 1105 of the first opening 805 with the finger 415 of the lock mechanism 405 can draw the battery pack 105 into the cavity 155 to couple the battery pack 105 with the actuator assembly 200 and with the frame 120 more generally. Coupling the battery pack 105 with the actuator assembly 200 can cause a seal 830 of the battery pack 105 to compress against the surface 205 within the cavity 155.

The second opening 810 can be an opening to receive at least a portion of the second lock mechanism 420. For example, the second opening 810 can be positioned radially outward from the axle 315 of the lock assembly 310 and can include a shape, form factor, or dimension that corresponds to a shape, form factor, or dimension of the end 425 the second lock mechanism 420. For example, the second lock mechanism 420 can be at least partially received by second opening when (a) the lock assembly 310, and thus the lock interface 800, is in the locked position 900; and (b) the second lock mechanism 420 is in the locked position. For example, when the lock assembly 310 is in the locked position 900, the second opening 810 of the lock interface 800 can at least partially align with (e.g., be substantially coaxial with) the end 425 of the second lock mechanism 420. The second lock mechanism 420 can move from the unlocked position to the locked position with the end 425 aligned with the second opening 810 of the lock interface 800. For example, the end 425 of the second lock mechanism 420 can have a shape, dimension, or form factor that corresponds to a shape, dimension, or form factor of the second opening 810 of the lock interface 800.

The bike 100 can include the second lock mechanism 420 to restrict or prohibit a movement of the lock assembly 310 when the second lock mechanism 420 is in the locked position. For example, the second lock mechanism 420 can be at least partially received in the second opening 810 so that the lock assembly 310 (e.g., the lock interface 800) cannot be rotated about the axis to defined by the axle 315. As noted above, the second lock mechanism 420 can move from the unlocked position to the locked position when the lock assembly 310 is first locked position 900. Accordingly, in some examples, a user can couple the battery pack 105 with the frame 120 of the bike in a two-step process including a first step of coupling, the battery pack 105 with the actuator assembly 200 by engaging the first lock mechanism 405 with the first opening 805 and rotating the lock assembly 310 from the unlocked position 700 to the locked position 900, and a second step of locking the battery pack 105 with the actuator assembly by moving the second lock mechanism 420 from the unlocked position to the locked position and into engagement with the second opening of the interface 800. This way, the lock assembly 310 of the battery can both physically couple the battery pack 105 with the frame 120 such that it cannot be removed from the frame 120, while the second lock mechanism 420 can prevent the lock assembly 310 from moving from the locked position 900 to the unlocked position 700 such that the battery pack 105 remains physically coupled to the frame 120 unless and until the second lock mechanism 420 returns to the unlocked position.

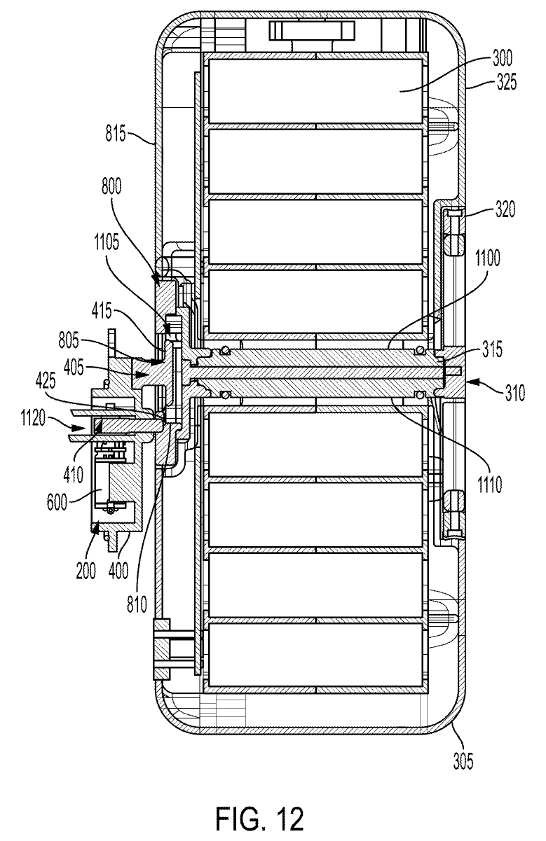

As depicted in FIGS. 11 and 12, among others, the bike 100 can include a shaft 1100 two couple the handle 320 with the lock interface 800. The shaft 1100 can define an axis about which the handle 320 rotates as the lock assembly is moved from the unlocked position 700 to locked position 900 or vice versa. The shaft 1100 can extend through the housing 305 via an opening 1110 (e.g., thru-bore, a passageway, or some other opening). The opening 1110 can extend from the first surface 325 to the second surface 815 of the housing 305 the battery pack 105. For example, the opening 1110 can extend through the battery pack 105 such that the opening 1110 is positioned between two or more battery cells 300 of the battery pack 105. In this way, the lock assembly 310 can extend through the battery pack 105. In other examples, the lock assembly 310 can extend between two other surfaces of the housing 305 of the battery pack 105.

The actuator assembly 200 can include a controlled device 1115. The control device 1115 can be a PCBA or some other control device that can control or influence an operation of the actuator assembly or some component coupled thereto. For example, the actuator assembly can include the motor 600 communicably coupled with the control device 1115 such that the controlled device 1115 can control an operation of the motor to, for example, move the mechanism from the unlocked position to the locked position or vice versa. The control device 1115 can be coupled with the control device 190, integrated with the control device 190, or the same as the control device 190, according to various examples.

The bike 100 can include at least one manual release opening 1120. The manual release opening 1120 can be an opening in the frame 120 or some other component of the bike 100 to provide access to the actuator assembly 200 from a backside (e.g., side opposite the surface 205 against the battery pack 105 can be coupled). For example, the opening 1120 can permit a user to manually actuate the motor 600 of the actuator assembly 200 to move the second lock mechanism 420 from a locked position to an unlocked position so the battery pack 105 can be removed from the cavity 155 in the event second lock mechanism 420 or the lock assembly 310 become jammed or otherwise stuck.

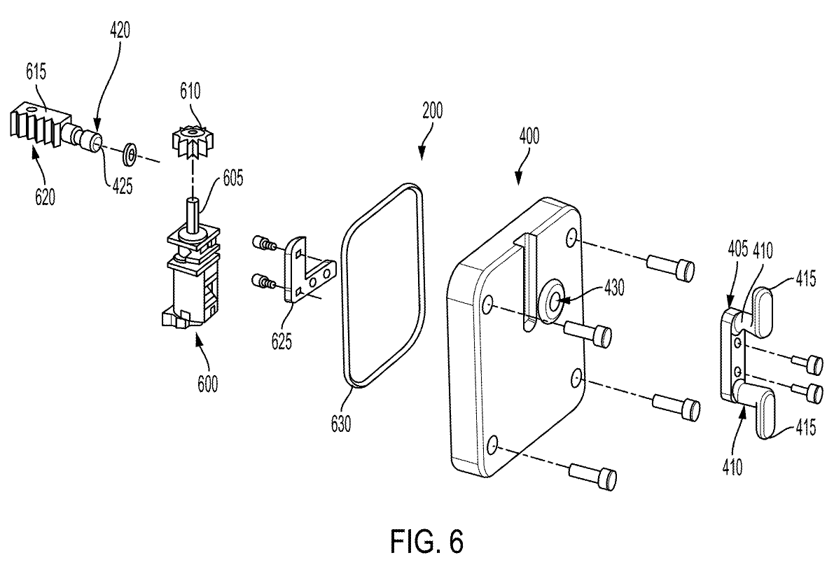

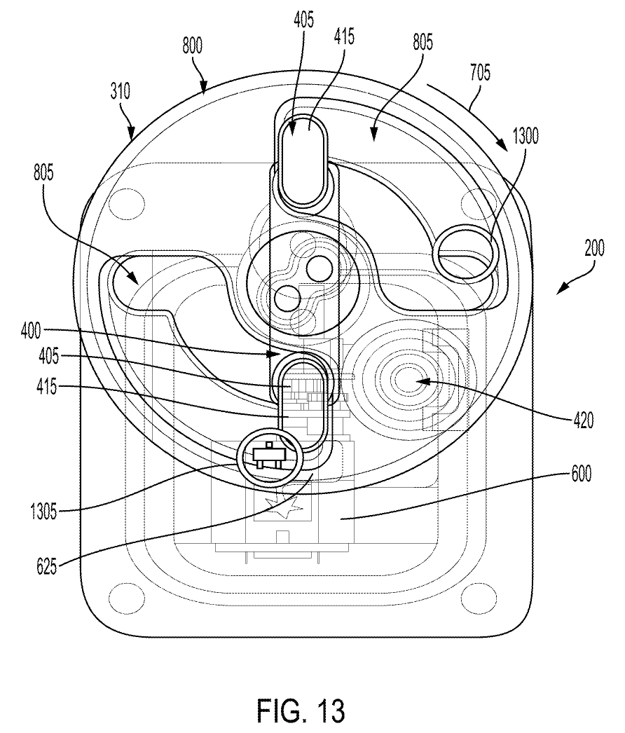

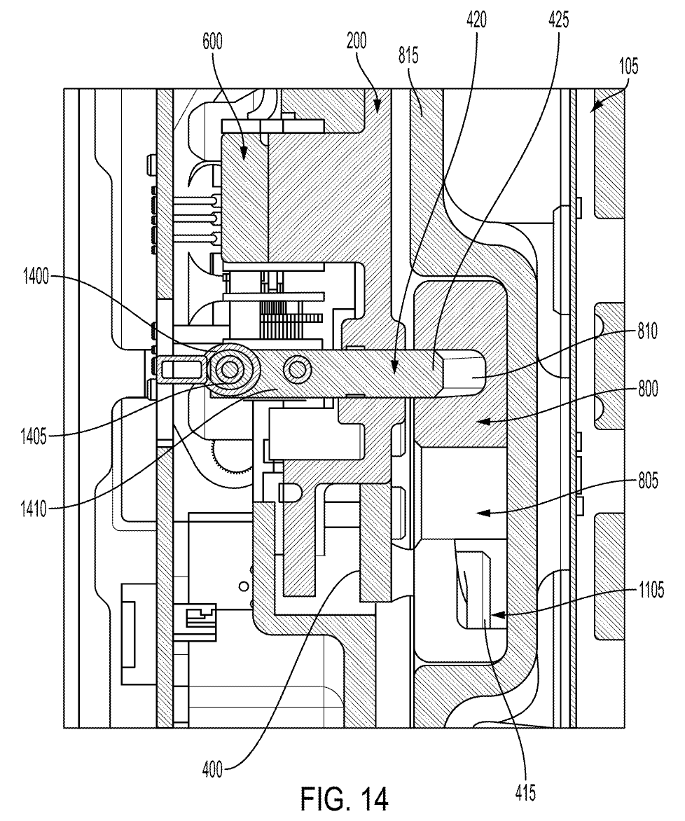

As depicted in FIGS. 6, 13, and 14, among others, the actuator assembly 200 can include at least one position sensor. For example, the position sensor can be a first position sensor 625, as depicted in FIGS. 6 and 13, or a second position sensor 1400, as depicted in FIG. 14, among others. The first position sensor 625 can be or include a hall effect sensor that can determine position of one component relative to another. For example, the actuator assembly 200 can include a first position sensor 625 that can determine a position of the lock interface 800 of the lock assembly 310 of the battery pack 105. The lock interface 800 can include at least one magnet 1300 or magnetic field generating component coupled to the lock interface 800 or positioned within the lock interface 800 (e.g., within the opening 805). The first position sensor 625 can include a sensor 1305 to detect a strength of a magnetic field generated by the magnet 1300 in order to determine a position of the magnet 1300 relative to the sensor 1305, where a position of the magnet 1300 relative to the sensor 1305 is indicative of a position of the lock interface 800. For example, the first position sensor 625 can determine whether the lock assembly 310 of the battery pack 105 is in the unlocked position 700 or the locked position 900. The first position sensor 625 can transmit a signal to the control device 190 that is indicative of the sensed (e.g., determined) position of the lock assembly 310 or the lock interface 800. The control device 190 can control an operation of the motor 600 alter position of the second lock mechanism 420 based on the signal from the first position sensor 625 indicative of the position of the lock interface 800. For example, the control device 190 can actuate the motor 600 to cause the second mechanism 420 to move from the unlocked position to a locked position in response to a signal from first position sensor 625 indicating that the interface 800 is in the locked position 900.

The second position sensor 1400 can be or include a hall effect sensor that can determine position of one component relative to another. For example, actuator assembly 200 can include the second position sensor 1400 to determine a position of the second lock mechanism 420. The second lock mechanism 420 can include at least one magnet 1410 or magnetic field generating component coupled to the body 615 or another portion of the second lock mechanism 420. The second position sensor 1400 can include a sensor 1405 to detect a strength of a magnetic field generated by the magnet 1410 in order to determine a position of the magnet 1410 relative to the sensor 1405, where a position of the magnet 1410 relative to the sensor 1405 is indicative of a position of the second lock mechanism 420. For example, the second position sensor 1400 can determine whether the second lock mechanism 420 of is in an unlocked position or a locked position. The second position sensor 1400 can transmit a signal to the control device 190 that is indicative of the sensed (e.g., determined) position of the second lock mechanism 420. The control device 190 can transmit a signal to the user interface 195 or some other component (e.g. a mobile application associated with a user’s mobile device, visual indicator such as a light, or some other component) in response to a determination that the second lock mechanism 420 is unable to move from the unlocked position to the locked position based on signal from the second position sensor 1400. For example, the control device 190 can determine, based on a signal from the second position sensor 1400, that the second lock mechanism 420 is jammed or is unable to move from the unlocked position to the locked position due to some obstruction or other error and communicate the jammed condition to the user.

FIG. 15 is a block diagram illustrating an architecture for a computer system 1500 that can be employed to implement elements of the systems and methods described and illustrated herein, including, for example, the bike 100, among others. For example, the control device 190 or some other control device of the bike 100 can be or include the computing system 1500 can include at least one bus 1505 or other communication component for communicating information and at least one processor 1510 or processing circuit coupled to the bus 1505 for processing information. The computing system 1500 can also include one or more processors 1510 or processing circuits coupled to the bus for processing information. The computing system 1500 also includes at least one main memory 1515, such as a random access memory (RAM) or other dynamic storage device, coupled to the bus 1505 for storing information, and instructions to be executed by the processor 1510. The main memory 1515 can be used for storing information during execution of instructions by the processor 1510. The computing system 1500 may further include at least one read only memory (ROM) 1520 or other static storage device coupled to the bus 1505 for storing static information and instructions for the processor 1510. A storage device 1525, such as a solid state device, magnetic disk or optical disk, can be coupled to the bus 1505 to persistently store information and instructions.

The computing system 1500 may be coupled via the bus 1505 to a display 1535, such as a liquid crystal display, or active matrix display, for displaying information to a user such as a rider of the bike 100 or other end user. An input device 1530, such as a keyboard or voice interface may be coupled to the bus 1505 for communicating information and commands to the processor 1510. The input device 1530 can include a touch screen display 1535. The input device 1530 can also include a cursor control, such as a mouse, a trackball, or cursor direction keys, for communicating direction information and command selections to the processor 1510 and for controlling cursor movement on the display 1535.

The processes, systems and methods described herein can be implemented by the computing system 1500 in response to the processor 1510 executing an arrangement of instructions contained in main memory 1515. Such instructions can be read into main memory 1515 from another computer-readable medium, such as the storage device 1525. Execution of the arrangement of instructions contained in main memory 1515 causes the computing system 1500 to perform the illustrative processes described herein. One or more processors in a multi-processing arrangement may also be employed to execute the instructions contained in main memory 1515. Hard-wired circuitry can be used in place of or in combination with software instructions together with the systems and methods described herein. Systems and methods described herein are not limited to any specific combination of hardware circuitry and software.

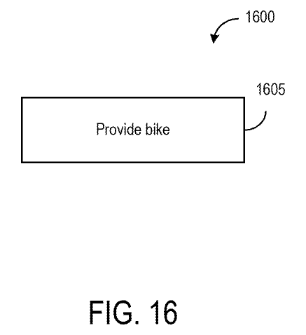

FIG. 16 is a flow diagram of an example method 1600 of providing the bike 100. The method 1600 can include at least one act of providing a bike 100 (e.g., act 1605). For example, providing the bike 100 can include (e.g., assembling or manufacturing) a bike 100 that includes a frame 120, a first wheel 140, a second wheel 140, and a drive unit 160 coupled with the frame 120. The frame 120 can include a cavity 155. An actuator assembly 200 can be positioned within the cavity 155. The actuator assembly 200 can engage with a battery pack 105. The method 1600 can include providing (e.g., assembling or manufacturing) the battery pack 105. The battery pack 105 can include a lock assembly 310 to engage with the actuator assembly 200 within the cavity 155. The lock assembly 310 can couple with the actuator assembly 200 to couple the battery pack 105 with the frame 120 of the bike 100.

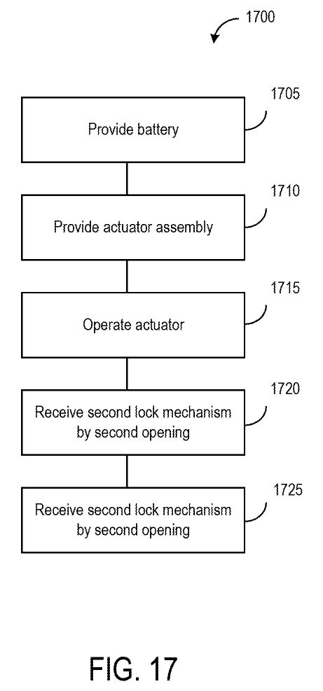

FIG. 17 is a flow diagram of an example method 1700 of coupling the battery pack 105 with the frame 120. The method 1700 can include at least one act of providing a battery pack 105 (e.g., act 1705). The battery pack 105 can include at least one lock assembly 310. The lock assembly 310 can selectively engage with an actuator assembly 200. For example, the lock assembly 310 can include a handle 320 coupled with a lock interface 800. The handle 320 can be coupled with the lock interface 800 via an axle 315. For example, the handle 320 and the lock interface 800 can rotate about an axis defined by the axle 315. As depicted in FIG. 3, among others, the handle 320 can be rotated about the axis defined by the axle 315 to move the lock assembly 310 from an unlocked position to a locked position or from a locked position to an unlocked position. The lock interface 800 can include at least one first opening 805. The lock interface 800 can include at least one second opening 810. The first opening 805 can be an opening to receive the lock mechanism 405 of the actuator assembly 200. For example, the first opening 805 can include a shape or form factor that, in at least some respects, corresponds to a shape or form factor of the finger 415 of the lock mechanism 405.

The method 1700 can include at least one act of providing an actuator assembly 200 (e.g., act 1710). The actuator assembly 200 can be coupled with the frame 120 (e.g., coupled with the surface 205, which can be part of the frame 120). For example, the actuator assembly 200 can be integrated with the frame 120 or otherwise a part of the frame 120. The actuator assembly 200 can include at least one first lock mechanism 405 and at least one second lock mechanism 420 (e.g., a pin). The second lock mechanism 420 can be movably coupled with the housing 400 such that a position of the second lock mechanism 420 can change with operation of the actuator assembly 200. The first lock mechanism 405 can include at least one projection 410. For example, the first mechanism 405 can include two projections 410 that are diametrically opposed. In other examples, the first mechanism 405 can include one projection 410 or some other number of projections 410 that can be diametrically opposed, or otherwise oriented. The projection 410 can include at least one finger 415. The finger 415 can extend radially or outward from the projection 410. The finger 415 can be positioned on a top or end of the projection 410. In various examples, each projection 410 can include at least one finger 415.

The method 1700 can include at least one act of receiving the first lock mechanism 405 by the first opening 805 (e.g., act 1715). For example, when the battery pack 105 is coupled with the actuator assembly 200, the finger 415 can be received by the first opening 805 of the lock interface. For example, the first opening 805 can include a portion 825 that has a shape and form factor that corresponds to a shape and form factor of the finger 415. The remaining portion of the first opening 805 (e.g., portions of first opening 805 other than the portion 825) can include a shape or form impact through that does not correspond to the 415 of the lock mechanism 405. For example, a remaining portion of the first opening 805 can include a shape or form factor that corresponds to the projection 410 of the lock assembly. The first opening 805 can receive the 415 of the lock mechanism 405 within the portion 825. The lock assembly 310 can be moved from the unlocked position 700 to the locked position 900 by rotating the lock assembly 310 (e.g., rotating the handle 320) in the direction 705. As the assembly 310 rotates in the direction 705 to move the lock assembly 310 from the unlocked position 700 to the locked position 900, the lock interface 800 can also rotate in the direction 705 with the finger 415 of the lock mechanism 405 the actuator assembly position within the opening 805. The finger 415 of the lock mechanism 405 can engage with the helical profile 1105 of the first opening 805. Engagement of the finger 415 with the helical profile 1105 of the first opening 805 allows the finger 415 to move in a direction toward the first surface 325 of the battery pack 105.

The method 1700 can include at least one act of operating the actuator 600 to move the second lock mechanism 420 from the unlocked position to the locked position (e.g., act 1720). For example, rotation of the gear 610 in a first direction based on a first actuation of the motor 600 can cause the second lock mechanism 420 to move from the unlocked position to the locked position. Rotation of the gear 610 in a second direction based on a second actuation of the motor 600 can cause the second lock mechanism 420 to move from the locked position to the unlocked position.

The method 1700 can include at least one act of receiving the second lock mechanism 420 by the second opening 810 (e.g., act 1725). The second lock mechanism 420 can be at least partially received by second opening when (a) the lock assembly 310, and thus the lock interface 800, is in the locked position 900; and (b) the second lock mechanism 420 is in the locked position. For example, when the lock assembly 310 is in the locked position 900, the second opening 810 of the lock interface 800 can at least partially align with (e.g., be substantially coaxial with) the end 425 of the second lock mechanism 420. The second lock mechanism 420 can move from the unlocked position to the locked position with the end 425 aligned with the second opening 810 of the lock interface 800. For example, the end 425 of the second lock mechanism 420 can have a shape, dimension, or form factor that corresponds to a shape, dimension, or form factor of the second opening 810 of the lock interface 800.

A user can couple the battery pack 105 with the frame 120 of the bike in a process including coupling, the battery pack 105 with the actuator assembly 200 by engaging the first lock mechanism 405 with the first opening 805 and rotating the lock assembly 310 from the unlocked position 700 to the locked position 900, and locking the battery pack 105 with the actuator assembly by moving the second lock mechanism 420 from the unlocked position to the locked position and into engagement with the second opening of the interface 800. This way, the lock assembly 310 of the battery can both physically couple the battery pack 105 with the frame 120 such that it cannot be removed from the frame 120, while the second lock mechanism 420 can prevent the lock assembly 310 from moving from the locked position 900 to the unlocked position 700 such that the battery pack 105 remains physically coupled to the frame 120 unless and until the second lock mechanism 420 returns to the unlocked position. In one or more examples, the present disclosure relates to a micromobility device (an example of which is a bicycle) configured to transport a rider and/or payload over short- to medium-distance trips and to operate in accordance with applicable mechanical, electrical, and operational standards. The micromobility device may be human-powered, electrically powered, or a hybrid thereof, and may include a structural body or frame configured to support one or more ground-engaging elements, a propulsion system, an energy storage system, a control system, and one or more rider or payload interfaces. The structural body may be rigid, semi-rigid, foldable, collapsible, telescoping, or modular, and may be formed from metal, polymer, composite, or hybrid materials, with mounting points for propulsion components, suspension elements, steering assemblies, braking systems, energy storage units, cargo accessories, and user-contact components such as seats, handlebars, platforms, pedals, or footrests. The micromobility device may include one or more ground-engaging elements such as wheels, rollers, tracks, or other rolling interfaces arranged in inline, staggered, or side-by-side configurations, with two, three, or more such elements depending on stability, maneuverability, or load requirements.

An apparatus can be a micromobility device. The micromobility device can include a frame. The frame can define a cavity. The micromobility device can include a first wheel and a second wheel rotatably coupled with the frame. The micromobility device can include a drive unit coupled with the frame. The drive unit can rotate the second wheel. The micromobility device can include an actuator assembly positioned within the cavity. The actuator assembly can include a first lock mechanism, a second lock mechanism, and an actuator. The actuator can move the second lock mechanism from an unlocked position to a locked position. The micromobility device can include a battery pack detachably coupled with the frame and positioned within the cavity. The battery pack can include a seal and a connector. The connector can be accessible from a surface of the battery pack and positioned within a perimeter of the seal. The battery pack can include a lock assembly. The lock assembly can include a handle coupled with a lock interface. The lock interface can define a first opening and a second opening, the handle to rotate the lock interface from a first position to a second position. The first opening can receive the first lock mechanism with the lock interface in the first position. The first opening can retain the first lock mechanism with the lock interface in the second position. The first opening can include a helical profile. The helical profile can engage the first lock mechanism to compress the battery pack against the cavity with the lock interface in the second position. The helical profile can engage the first lock mechanism to compress the seal of the battery pack against the cavity with the lock interface in the second position. The actuator can move the second lock mechanism to the locked position with the lock interface in the second position. The second opening can receive the second lock mechanism with the lock interface in the second position and the second lock mechanism in the locked position. The battery pack can be coupled with the frame with the lock interface in the second position and the second lock mechanism in the locked position.

The battery pack of the micromobility device can include a plurality of battery cells positioned within a housing. The housing can include a first surface and a second surface opposite the first surface. The handle of the lock assembly can be positioned proximate the first surface. The lock interface of the lock assembly can be positioned proximate the second surface. The handle can be coupled with the lock interface via an axle. The axle can extend from the first surface of the housing to the second surface of the housing such that the handle of the lock assembly is positioned proximate the first surface. The battery pack can include a passageway. The handle can be coupled with the lock interface via the axle. The axle can extend from the first surface of the housing to the second surface of the housing through the passageway such that the handle of the lock assembly is positioned proximate the first surface. The handle can be rotated about an axis defined by the axle without the use of tools. In the first position, the handle can extend from the battery pack. In the second position the handle can be parallel to the first surface of the housing. The lock assembly can be locked by the actuator.

An apparatus can be a micromobility device. The micromobility device can include a frame. The frame can define a cavity. The micromobility device can include a first wheel and a second wheel rotatably coupled with the frame. The micromobility device can include a drive unit coupled with the frame. The drive unit can rotate the second wheel. The micromobility device can include an actuator assembly positioned within the cavity. The actuator assembly can include a first lock mechanism, a second lock mechanism, and an actuator. The actuator can move the second lock mechanism from an unlocked position to a locked position. The micromobility device can include a battery pack detachably coupled with the frame and positioned within the cavity. The battery pack can include a lock assembly. The lock assembly can include a handle coupled with a lock interface. The lock interface can define a first opening and a second opening, the handle to rotate the lock interface from a first position to a second position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position. The battery pack can be coupled with the frame with the lock interface in the second position and the second lock mechanism in the locked position. A first magnet can be coupled with the lock interface. A second magnet coupled with the actuator assembly. A position sensor can determine a position of the lock interface based on a position of the first magnet relative to the second magnet. The micromobility device can include a control device communicably coupled with the actuator. The control device can cause the actuator assembly to move the second lock mechanism from the unlocked position to the locked position based on the determined position of the lock interface. The first magnet or a third magnet can be coupled with the second lock mechanism. The second magnet can be coupled with the actuator assembly. The position sensor can determine a position of the second lock mechanism based on a position of the first magnet relative to the second magnet.

At least one aspect is directed to an apparatus. The apparatus can be a micromobility device. The micromobility device can include a frame. The frame can define a cavity. The micromobility device can include a first wheel and a second wheel rotatably coupled with the frame. The micromobility device can include a drive unit coupled with the frame. The drive unit can rotate the second wheel. The micromobility device can include an actuator assembly positioned within the cavity. The actuator assembly can include a first lock mechanism, a second lock mechanism, and an actuator. The actuator can move the second lock mechanism from an unlocked position to a locked position. The actuator can include a moto. The motor can couple with the second lock mechanism via a gear. The motor can cause the gear to rotate to move the second lock mechanism between the locked position and the unlocked position. The micromobility device can include a battery pack detachably coupled with the frame and positioned within the cavity. The battery pack can include a lock assembly. The lock assembly can include a handle coupled with a lock interface. The lock interface can define a first opening and a second opening, the handle to rotate the lock interface from a first position to a second position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position. The battery pack can be coupled with the frame with the lock interface in the second position and the second lock mechanism in the locked position.

An apparatus can be a micromobility device. The micromobility device can include a frame. The frame can define a cavity. The micromobility device can include a first wheel and a second wheel rotatably coupled with the frame. The micromobility device can include a drive unit coupled with the frame. The drive unit can rotate the second wheel. The micromobility device can include an actuator assembly positioned within the cavity. The actuator assembly can include a first lock mechanism, a second lock mechanism, and an actuator. The actuator can move the second lock mechanism from an unlocked position to a locked position. The actuator can include a moto. The motor can couple with the second lock mechanism via a gear. The motor can cause the gear to rotate to move the second lock mechanism between the locked position and the unlocked position. The micromobility device can include a battery pack detachably coupled with the frame and positioned within the cavity. The battery pack can include a seal and a connector. The connector can be accessible from a surface of the battery pack and positioned within a perimeter of the seal. The battery pack can include a lock assembly. The lock assembly can include a handle coupled with a lock interface. The lock interface can define a first opening and a second opening, the handle to rotate the lock interface from a first position to a second position. The first opening can receive the first lock mechanism with the lock interface in the first position. The first opening to retain the first lock mechanism with the lock interface in the second position. The first opening can include a helical profile. The helical profile can engage the first lock mechanism to compress the battery pack against the cavity with the lock interface in the second position. The helical profile can engage the first lock mechanism to compress the seal of the battery pack against the cavity with the lock interface in the second position. The actuator can move the second lock mechanism to the locked position with the lock interface in the second position. The second opening can receive the second lock mechanism with the lock interface in the second position and the second lock mechanism in the locked position. The battery pack can be coupled with the frame with the lock interface in the second position and the second lock mechanism in the locked position.

An apparatus can be a micromobility device. A micromobility device can include a frame. The frame can define a cavity. The micromobility device can include a first wheel and a second wheel rotatably coupled with the frame. The micromobility device can include a drive unit coupled with the frame. The drive unit can rotate the second wheel. The micromobility device can include an actuator assembly positioned within the cavity. The actuator assembly can include a first lock mechanism, a second lock mechanism, and an actuator. The actuator can move the second lock mechanism from an unlocked position to a locked position. The micromobility device can include a battery pack detachably coupled with the frame and positioned within the cavity. The battery pack can include a lock assembly. The battery pack of the micromobility device can include a plurality of battery cells positioned within a housing. The battery pack can include a passageway. The housing can include a first surface and a second surface opposite the first surface. The handle of the lock assembly can be positioned proximate the first surface. The handle can be coupled with the lock interface via an axle. The axle can extend from the first surface of the housing to the second surface of the housing such that the handle of the lock assembly is positioned proximate the first surface. The axle can extend from the first surface of the housing to the second surface of the housing through the passageway such that the handle of the lock assembly is positioned proximate the first surface. The handle can be rotated about an axis defined by the axle without the use of tools. In the first position, the handle can extend from the battery pack. In the second position the handle can be parallel to the first surface of the housing. The lock assembly can be locked by the actuator. The lock interface can define a first opening and a second opening, the handle to rotate the lock interface from a first position to a second position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position. The battery pack can be coupled with the frame with the lock interface in the second position and the second lock mechanism in the locked position. The lock interface of the lock assembly can be positioned proximate the second surface. The lock interface can be positioned proximate the second surface.

An apparatus can be a battery pack. The battery pack can include a lock assembly. The lock assembly can include a handle coupled with a lock interface. The lock interface can define a first opening and a second opening. The first opening can include a helical profile. The helical profile can engage the first lock mechanism to compress the battery pack against a cavity of a frame with the lock interface in the second position. The battery pack can include a seal and a connector. The connector can be accessible from a surface of the battery pack and positioned within a perimeter of the seal. The helical profile can engage the first lock mechanism to compress the seal of the battery pack against a cavity of a frame with the lock interface in the second position. The handle can rotate the lock interface from a first position to a second position. The battery pack can include or be selectively coupled with an actuator assembly. The actuator assembly can include a first lock mechanism, a second lock mechanism, and an actuator. The actuator can move the second lock mechanism from an unlocked position to a locked position. The actuator can include a motor coupled with the second lock mechanism via a gear, the motor to cause the gear to rotate to move the second lock mechanism between the locked position and the unlocked position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position.

The battery pack can include a plurality of battery cells positioned within a housing. The housing can include a first surface and a second surface opposite the first surface. The handle of the lock assembly can be positioned proximate the first surface. The lock interface of the lock assembly positioned can be positioned proximate the second surface. The handle can be coupled with the lock interface via an axle. The axle can extend from the first surface of the housing to the second surface of the housing such that the handle of the lock assembly is positioned proximate the first surface. The battery pack can include a passageway. The axle can extend from the first surface of the housing to the second surface of the housing through the passageway such that the handle of the lock assembly is positioned proximate the first surface. The handle can be rotated about an axis defined by the axle without the use of tools. In the first position, the handle can extend from the battery pack. In the second position the handle can be parallel to the first surface of the housing. The lock assembly can be locked by the actuator.

An apparatus can be a battery pack. The battery pack can include a lock assembly. The lock assembly can include a handle coupled with a lock interface. The lock interface can define a first opening and a second opening. The handle can rotate the lock interface from a first position to a second position. The battery pack can include or be selectively coupled with an actuator assembly. The actuator assembly can include a first lock mechanism, a second lock mechanism, and an actuator. The actuator can move the second lock mechanism from an unlocked position to a locked position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position. A first magnet can be coupled with the lock interface. A second magnet coupled with the actuator assembly. A position sensor can determine a position of the lock interface based on a position of the first magnet relative to the second magnet. The battery pack can include a control device communicably coupled with the actuator. The control device can cause the actuator assembly to move the second lock mechanism from the unlocked position to the locked position based on the determined position of the lock interface. The first magnet or a third magnet can be coupled with the second lock mechanism. The second magnet can be coupled with the actuator assembly. The position sensor can determine a position of the second lock mechanism based on a position of the first magnet relative to the second magnet.

An apparatus can be a battery pack. The battery pack can include a plurality of battery cells positioned within a housing. The housing can include a first surface and a second surface opposite the first surface. The battery pack can include a lock assembly. The lock assembly can include a handle coupled with a lock interface. The lock interface of the lock assembly positioned can be positioned proximate the second surface. The lock interface can define a first opening and a second opening. The handle can rotate the lock interface from a first position to a second position. The handle of the lock assembly can be positioned proximate the first surface. The battery pack can include or be selectively coupled with an actuator assembly. The actuator assembly can include a first lock mechanism, a second lock mechanism, and an actuator. The actuator can move the second lock mechanism from an unlocked position to a locked position. The first opening can receive the first lock mechanism with the lock interface in the first position. The first opening can retain the first lock mechanism with the lock interface in the second position. The actuator can move the second lock mechanism to the locked position with the lock interface in the second position. The second opening can receive the second lock mechanism with the lock interface in the second position and the second lock mechanism in the locked position. The handle can be coupled with the lock interface via an axle. The axle can extend from the first surface of the housing to the second surface of the housing such that the handle of the lock assembly is positioned proximate the first surface. The battery pack can include a passageway. The axle can extend from the first surface of the housing to the second surface of the housing through the passageway such that the handle of the lock assembly is positioned proximate the first surface. The handle can be rotated about an axis defined by the axle without the use of tools. In the first position, the handle can extend from the battery pack. In the second position the handle can be parallel to the first surface of the housing. The lock assembly can be locked by the actuator.

A method can include providing a battery pack. The battery pack can include a lock assembly. The lock assembly can include a handle coupled with a lock interface. The lock interface can define a first opening and a second opening. The handle can rotate the lock interface from a first position to a second position. The handle can be rotated about an axis defined by the axle without the use of tools. In the first position, the handle can extend from the battery pack. In the second position the handle can be parallel to the first surface of the housing. The lock assembly can be locked by the actuator. The method can include providing an actuator assembly. The actuator assembly can include a first lock mechanism, a second lock mechanism, and an actuator. The actuator can move the second lock mechanism from an unlocked position to a locked position. The method can include receiving, by the first opening, the first lock mechanism with the lock interface in the first position. The first opening can retain the first lock mechanism with the lock interface in the second position. The method can include operating the actuator can move the second lock mechanism to the locked position with the lock interface in the second position. The method can include receiving, by second opening, the second lock mechanism with the lock interface in the second position and the second lock mechanism in the locked position.

The method can include coupling a first magnet with the lock interface. The method can include coupling a second magnet coupled with the actuator assembly. The method can include determining a position of the lock interface based on a position of the first magnet relative to the second magnet. The method can include causing the actuator assembly to move the second lock mechanism from the unlocked position to the locked position based on the determined position of the lock interface. The method can include coupling the first magnet or a third magnet with the second lock mechanism and coupling a second magnet with the actuator assembly. The method can include determining a position of the second lock mechanism based on a position of the first magnet relative to the second magnet.

In various embodiments, the micromobility device may be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A micromobility device, comprising:
a frame defining a cavity;
a first wheel and a second wheel rotatably coupled with the frame;
a drive unit coupled with the frame, the drive unit configured to rotate the second wheel;
an actuator assembly positioned within the cavity, the actuator assembly including a first lock mechanism, a second lock mechanism, and an actuator, the actuator configured to move the second lock mechanism from an unlocked position to a locked position;
a battery pack detachably coupled with the frame and positioned within the cavity, the battery pack including a lock assembly, the lock assembly including a handle coupled with a lock interface, the lock interface defining a first opening and a second opening, the handle configured to rotate the lock interface from a first position to a second position;
the first opening configured to receive the first lock mechanism with the lock interface in the first position, the first opening configured to retain the first lock mechanism with the lock interface in the second position;
the actuator configured to move the second lock mechanism to the locked position with the lock interface in the second position, the second opening configured to receive the second lock mechanism with the lock interface in the second position and the second lock mechanism in the locked position; and
the battery pack coupled with the frame with the lock interface in the second position and the second lock mechanism in the locked position.

2. The micromobility device of claim 1, comprising:
the first opening of the lock interface including a helical profile, the helical profile configured to engage the first lock mechanism to compress the battery pack against the cavity with the lock interface in the second position.

3. The micromobility device of claim 1, comprising:
the battery pack including a seal and a connector, the connector accessible from a surface of the battery pack and positioned within a perimeter of the seal; and
the first opening of the lock interface including a helical profile, the helical profile configured to engage the first lock mechanism to compress the seal of the battery pack against the cavity with the lock interface in the second position.

4. The micromobility device of claim 1, comprising:
the battery pack including a plurality of battery cells positioned within a housing, the housing including a first surface and a second surface opposite the first surface, the handle of the lock assembly positioned proximate the first surface, the lock interface of the lock assembly positioned proximate the second surface.

5. The micromobility device of claim 1, comprising:
the battery pack including a plurality of battery cells positioned within a housing, the housing including a first surface and a second surface opposite the first surface; and
the lock assembly including the handle coupled with the lock interface via an axle, the axle extending from the first surface of the housing to the second surface of the housing such that the handle of the lock assembly is positioned proximate the first surface, the lock interface positioned proximate the second surface.

6. The micromobility device of claim 1, comprising:
the battery pack including a plurality of battery cells positioned within a housing, the housing including a first surface, a second surface opposite the first surface, and a passageway; and
the lock assembly including the handle coupled with the lock interface via an axle, the axle extending from the first surface of the housing to the second surface of the housing through the passageway such that the handle of the lock assembly is positioned proximate the first surface, the lock interface positioned proximate the second surface.

7. The micromobility device of claim 1, comprising:
a first magnet coupled with the lock interface;
a second magnet coupled with the actuator assembly;
a position sensor to determine a position of the lock interface based on a position of the first magnet relative to the second magnet; and
a control device communicably coupled with the actuator, the control device to cause the actuator assembly to move the second lock mechanism from the unlocked position to the locked position based on the determined position of the lock interface.

8. The micromobility device of claim 1, comprising:
a first magnet coupled with the lock interface;
a second magnet coupled with the actuator assembly; and
a position sensor to determine a position of the lock interface based on a position of the first magnet relative to the second magnet.

9. The micromobility device of claim 1, comprising:
a first magnet coupled with the second lock mechanism;
a second magnet coupled with the actuator assembly; and
a position sensor to determine a position of the second lock mechanism based on a position of the first magnet relative to the second magnet.

10. The micromobility device of claim 1, comprising:
the actuator including a motor, the motor to couple with the second lock mechanism via a gear, the motor to cause the gear to rotate to move the second lock mechanism between the locked position and the unlocked position.

11. A battery pack assembly, comprising:
a battery pack including a lock assembly, the lock assembly including a handle coupled with a lock interface, the lock interface defining a first opening and a second opening, the handle configured to rotate the lock interface from a first position to a second position;
an actuator assembly including a first lock mechanism, a second lock mechanism, and an actuator, the actuator configured to move the second lock mechanism from an unlocked position to a locked position;
the first opening configured to receive the first lock mechanism with the lock interface in the first position, the first opening configured to retain the first lock mechanism with the lock interface in the second position; and
the actuator configured to move the second lock mechanism to the locked position with the lock interface in the second position, the second opening configured to receive the second lock mechanism with the lock interface in the second position and the second lock mechanism in the locked position.

12. The battery pack assembly of claim 11, comprising:
the first opening of the lock interface including a helical profile, the helical profile configured to engage the first lock mechanism to compress the battery pack against a cavity of a frame with the lock interface in the second position.

13. The battery pack assembly of claim 11, comprising:
the battery pack including a seal and a connector, the connector accessible from a surface of the battery pack and positioned within a perimeter of the seal; and
the first opening of the lock interface including a helical profile, the helical profile to engage the first lock mechanism to compress the seal of the battery pack against a cavity of a frame with the lock interface in the second position.

14. The battery pack assembly of claim 11, comprising:
the battery pack including a plurality of battery cells positioned within a housing, the housing including a first surface and a second surface opposite the first surface, the handle of the lock assembly positioned proximate the first surface, the lock interface of the lock assembly positioned proximate the second surface.

15. The battery pack assembly of claim 11, comprising:
the battery pack including a plurality of battery cells positioned within a housing, the housing including a first surface and a second surface opposite the first surface; and
the lock assembly including the handle coupled with the lock interface via an axle, the axle extending from the first surface of the housing to the second surface of the housing such that the handle of the lock assembly is positioned proximate the first surface, the lock interface positioned proximate the second surface.

16. The battery pack assembly of claim 11, comprising:
the battery pack including a plurality of battery cells positioned within a housing, the housing including a first surface, a second surface opposite the first surface, and a passageway; and
the lock assembly including the handle coupled with the lock interface via an axle, the axle extending from the first surface of the housing to the second surface of the housing through the passageway such that the handle of the lock assembly is positioned proximate the first surface, the lock interface positioned proximate the second surface.

17. The battery pack assembly of claim 11, comprising:
a first magnet coupled with the lock interface;
a second magnet coupled with the actuator assembly;
a position sensor to determine a position of the lock interface based on a position of the first magnet relative to the second magnet; and
a control device communicably coupled with the actuator, the control device to cause the actuator assembly to move the second lock mechanism from the unlocked position to the locked position based on the determined position of the lock interface.

18. The battery pack assembly of claim 11, comprising:
a first magnet coupled with the lock interface;
a second magnet coupled with the actuator assembly; and
a position sensor to determine a position of the lock interface based on a position of the first magnet relative to the second magnet.

19. The battery pack assembly of claim 11, comprising:
a first magnet coupled with the second lock mechanism;
a second magnet coupled with the actuator assembly; and
a position sensor to determine a position of the second lock mechanism based on a position of the first magnet relative to the second magnet.

20. A method of coupling a battery pack with a bike, comprising:
providing the battery pack including a lock assembly, the lock assembly including a handle coupled with a lock interface, the lock interface defining a first opening and a second opening, the handle to rotate the lock interface from a first position to a second position;
providing an actuator assembly including a first lock mechanism, a second lock mechanism, and an actuator, the actuator to move the second lock mechanism from an unlocked position to a locked position;
receiving, by the first opening of the battery pack, the first lock mechanism with the lock interface in the first position, the first opening to retain the first lock mechanism with the lock interface in the second position;
operating the actuator to move the second lock mechanism to the locked position with the lock interface in the second position; and
receiving, by the second opening of the battery pack, the second lock mechanism with the lock interface in the second position and the second lock mechanism in the locked position.
